(19) United States
(12) Patent Application Publication
(10) Pub. No.: US 2009/0235063 A1
(43) Pub. Date: Sep. 17, 2009

(54) EXECUTION OF COMPUTER INSTRUCTIONS WITH RECONFIGURABLE HARDWARE

(75) Inventors: Boris Skoric, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/306,124

(22) PCT Filed: Jul. 2, 2007
(86) PCT No.: PCT/IB07/52551

§ 371 Date: Dec. 22, 2008

(30) Foreign Application Priority Data
Jul. 4, 2006 (EP) 06116534.6

(51) Int. Cl. G06F 9/44

(52) U.S. Cl. 713/100; 726/27; 713/190

(57) ABSTRACT

The invention relates the executing of computer readable instructions on a hardware platform (301) comprising a reconfigurable hardware component (311), such as a field-programmable gate array (FPGA). The reconfigurable hardware component is reconfigured in accordance with a reconfiguration set, and a first application is executed at least partly on the reconfigured hardware component, thereby generating an output. The invention provides a way of obfuscating and tamper-proofing software to be executed on a hardware platform.

### FIELD OF THE INVENTION

The invention relates to a method of executing computer readable instructions on a hardware platform comprising a reconfigurable hardware component. Moreover, the invention relates to a computer program product and to a device for implementing the method.

### BACKGROUND OF THE INVENTION

Software vendors selling software that runs on an open platform may face a fundamental problem. This occurs in the situation that the software contains secrets that should remain hidden, e.g. proprietary algorithms and cryptographic keys in digital rights management (DRM) applications. On an open platform, a person having obtained a copy of a program has the full power to scrutinize and disassemble the code of the program, e.g. by reverse engineering, thereby gaining insight into or even access to passwords, keys, certificates, and to learn specific algorithms, etc. Such a person is often referred to as an attacker. It may also be possible to modify the code, e.g. by bypassing IF statements, replacing keys, removing/inserting code. As a result such a person may cause the code to stop behaving according to compliance rules, inject a virus/worm/Trojan horse etc.

Attacks of a software code may be hampered by software obfuscation, where the code is transformed into an obfuscated form where the code is hard to understand, and therefore also hard to gain insight into or reverse engineer.

In the Article “Flexible Software Protection Using Hardware/Software Codesign Techniques”, Proceedings of the Design, Automation and Test in Europe Conference and Exhibition (DATE'04), pp. 636, 2004 by Zambreno, J. et al. a method of coupling a protective compiler technique with reconfigurable hardware support is disclosed. In the article it is disclosed that a processor is supplemented with an FPGA-based (field-programmable gate array based) secure hardware component.

### SUMMARY OF THE INVENTION

The present invention seeks to provide an improved way of executing computer instructions on a hardware platform, and it may be seen as an object of the invention to provide means for executing computer instructions on a hardware platform in a secure way so that tampering, reverse engineering and other attacks on the software code is inhibited or at least rendered complicated. In the article by Zambreno et al. as mentioned above, a field-programmable gate array (FPGA) is used to perform consistency checks on executable code that is run on an ordinary CPU in the usual way. The inventors of the present invention have had the insight that by use of a generic implementation in a FPGA or another reconfigurable hardware component on which custom made computer instructions can be executed, an improved and advantageous way of tamper-proofing a hardware platform is provided. Preferably, the invention alleviates, mitigates or eliminates one or more disadvantages of the prior art singly or in any combination.

According to a first aspect of the present invention there is provided a method of executing computer readable instructions on a hardware platform comprising a reconfigurable hardware component, the method comprising:
reconfigure the reconfigurable hardware component in accordance with a reconfiguration set;
execute a first application at least partly on the reconfigured hardware component and generate an output from the first application.

The invention provides a method of obfuscating and tamper-proofing software to be executed on a hardware platform. After reconfiguration of the reconfigurable hardware component, an attacker is in effect faced with a new and unknown hardware platform with each new software application (or even a new release of the same application). No tools are thereby available to disassemble the code or instructions running on this new platform. The instructions for reconfiguring the reconfigurable hardware component may be part of the first application. Alternatively, a separate application is executed for this purpose. The reconfiguration set may be provided together with or separate from the first application. For example, the reconfiguration set may be part of the first application, they (i.e. the reconfiguration set and the first application) may be separate entities, but provided together, e.g. on a storage device, or they may be separate entities where the first application is instructed how to access the reconfiguration set, e.g. via a network, via a storage device, etc.

The reconfigurable hardware component may in an advantageous embodiment be an FPGA, but other types of reconfigurable hardware component may alternatively be used. A reconfigurable hardware component is more difficult to run-time observe than activities going on in a standard PC memory. Attackers may typically monitor the traffic on the bus in connection with scrutinizing an application. For a reconfigurable hardware component, such as an FPGA, no bus is present and it may therefore be difficult or even impossible to access the data sent to and from the FPGA and the data being processed inside the FPGA. In consequence, a situation may be provided by the present invention where the reconfigurable hardware component cannot be run-time inspected by a fixed hardware component.

Advantageous embodiments are disclosed where the reconfigurable hardware component may be set to operate in different modes, or as a combination of operation modes, including operating as a CPU, being adapted for parallel processing or forming a neural network. It is advantageous to be able to apply different operation modes, since a versatile a flexible way of securing software from being attacked is thereby provided.

Advantageous embodiments are disclosed where an access level may be set in dependence on the output of the first application. The access level may be set in dependence upon integrity test on various parts of the hardware platform or associated to the hardware platform. Setting an access level is an advantageous way of providing conditional access to data, to software and hardware applications, to services, to connections, etc.

In advantageous embodiments, the first application enables execution of instructions, such as decryption instructions associated with encrypted content, e.g. accompanying the encrypted content, thereby rendering secure access to encrypted content. The reconfiguration set may be accompanied by the encrypted content, e.g. the reconfiguration set may be delivered along with the encrypted content. Delivering the reconfiguration set along with the encrypted content may be a convenient way of providing a configuration set.

As a further advantage, the invention allows for obfuscating the reconfigurable hardware component functionality in such a way that the functionality is not apparent from inspection of the reconfiguration data. In effect, the obfuscated code or instructions is even harder to reverse engineer than a non-obfuscated reconfigurable hardware component.

In other aspects of the invention there are provided a computer program product arranged to cause a processor to execute the method of the first aspects, as well as a device comprising a hardware platform and a reconfigurable hardware component, arranged to perform the method of the first aspect.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a general schematic overview of the relation between the first application and a hardware platform;

FIG. 2 illustrates a flow diagram of embodiments of the invention; and

FIG. 3 illustrates a rendering device equipped with a hardware platform in accordance with an embodiment of the present invention.

### DESCRIPTION OF EMBODIMENTS

In the present invention reconfigurable hardware is used for the purpose of software obfuscation on platforms where a person has full power to scrutinize an application. Software carries instructions for reconfiguring the hardware and further instructions that are to be executed on the newly configured hardware. The new configuration represents a new platform, not yet known to attackers, which facilitates the obfuscation of the software.

In an embodiment, the processor of the hardware platform is supplemented with a reconfigurable hardware component being a field-programmable gate array (FPGA) on which a soft microprocessor is implemented, i.e. the reconfiguration set describes a microprocessor, thereby combining reconfigurable logic with a general-purpose CPU. In this scheme, a special computer language compiler compiles subroutines into a bit-mask to configure the logic. Other, typically less critical, parts of the program can be run by sharing their time on the CPU. The FPGA is a semiconductor device which contains programmable logic components, like OR and NAND gates. Such gates can be combined in a programmable way to more complex functions, and it is even possible to “program” microprocessor functionality, including its own instruction set, on an FPGA. By reprogramming an FPGA new functionality can be obtained. Alternative other types of programmable logic devices may be used instead of a FPGA, e.g. a Complex Programmable Logic Device (CPLD). The behavior of the FPGA may be defined by means of a hardware description language (HDL), e.g. VHDL and Verilog, by defining the reconfiguration set in terms of the HDL used.

The hardware platform may be implemented as a part of a variety of hardware platforms for different specific purposes. In typical implementations the hardware platform may be implemented in a general purpose computer or a rendering device, such as a hard disk recorder or a DVD device. The hardware platform may e.g. be or be part of a motherboard supporting the functionality of a reconfigurable hardware component.

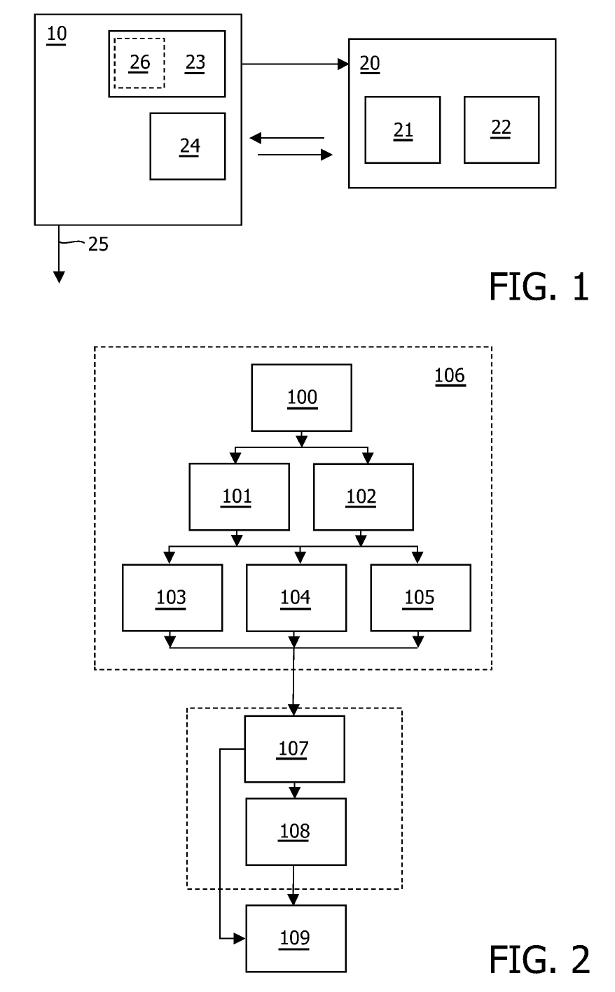

An embodiment of the invention is illustrated in FIG. 1. The Figure is a general schematic overview of the relation between the first application 10 and a hardware platform 20. In the Figure a software application 10 is executed on a hardware platform. The hardware platform 20 comprises a reconfigurable hardware component 21 and a fixed hardware component 22. The reconfigurable hardware component may be an FPGA whereas the fixed hardware component may be a central processing unit (CPU). The software application 10 carries instructions 23 for reconfiguring the reconfigurable hardware component in accordance with a reconfiguration set 26, so that the reconfigurable hardware component is enabled to process data and/or instructions. The software application also carries instructions 24 that is meaningless, or at least parts of the instructions are meaningless, to the fixed hardware component, but instead has to be processed at least partly by the reconfigurable hardware component. The software application 10 may be a first application. The first application 10 generates an output 25 in response to being executed on the hardware platform 20.

The output may be part of a routine to ensure conditional access, e.g. to ensure access to content if the output fulfils a given criterion. The specific condition or conditions to be met may depend on a specific embodiment. The conditional access may be expressed in terms of setting an access level in accordance with the output of the first application, e.g. if it fulfils a given criterion.

FIG. 2 illustrates a flow diagram of embodiments of the invention. In a first step 100, the FPGA (i.e. the reconfigurable hardware component) is reconfigured. In an embodiment, the fixed platform may require to reboot 101 after reconfiguration of the FPGA. Alternatively, the hardware platform may be reconfigured on-the-fly 102. For hardware platforms where on-the-fly reconfigurations are possible, frequent reconfigurations can be performed in dependence upon interim outcomes of processes.

The reconfiguration of the hardware component may set the hardware platform to operate in a number of modes. A non-exhaustive list includes that the reconfigurable hardware component may be configured to operate with the function of a CPU 103. The reconfigured hardware component may be configured so that it is adapted for parallel processing 104. Programs written for parallel execution require special disassembly tools, and may consequently be even harder to reverse engineer. The reconfigured hardware component may be configured to form a neural network 105. Neural networks may operate in a way that is hard to understand, and the disassembly of such actions is different from the disassembly of ordinary executable code or instructions, and may consequently also be very hard, if not impossible to reverse engineer.

Having reconfigured the reconfigurable hardware component to operate in accordance with an operation mode 106, the first application continues the execution 107 of the parts of the application to be executed on the reconfigured hardware component. The processing of the first application may be shared between a fixed hardware component, e.g. a fixed CPU and the reconfigured hardware component. The application may include code to instruct either the fixed CPU or the reconfigured hardware component, which parts of the code is to be executed where. The first application generates an output 108 to be used for further action.

The output 108 may be used by the first application to set an access level allowed by the user. The access level may e.g. grant complete access or no access at all. Alternative, the access level may grant access to a set of functionality of the first or other application. The output may alternatively be communicated to another entity than the first application. For example to a verifier ensuring that an application can correctly respond to challenges. The verifier may be a software application, another application running on the reconfigured hardware component, a control application of a device, an online service provider, etc.

The output may be the result of an integrity test of the application itself. The application may perform checksums or perform other computations for checking that the application indeed is in the original form. If the integrity test is successful, the level of access may be set to full access, alternatively the level of access may be set so that further use of the application is inhibited.

The output may alternatively (or in addition) be the result (or combined result) of an integrity test on the reconfigurable hardware component. The application may perform tests of the reconfigurable hardware component to ensure that the actual functionality matches the intended functionality.

The output may alternatively (or in addition) be the result (or combined result) of an integrity test on a software application running on the hardware platform, or the part of a software application running on the hardware platform. For example, a program running on the fixed hardware platform.

The level of access may be dependent upon the execution of a second application running on the hardware platform. The second application may be a software application downloaded or installed together with the first application for reconfigurable hardware component. The second application may be a security application running on the reconfigured hardware component. The second application may also be a control application of a device.

In an embodiment the first application may enable execution of decryption instructions accompanying encrypted content, thereby enabling access to encrypted content. This is further elaborated upon below.

Having successfully executed the first application, a further operation 109 may be enabled, so that a user may continue to use the functionality of either the first application or of another application connected to the first application.

An embodiment in accordance with the present invention is now described in connection with accessing protected content. That is, an embodiment of the present invention to be used in connection with digital rights management (DRM) is described.

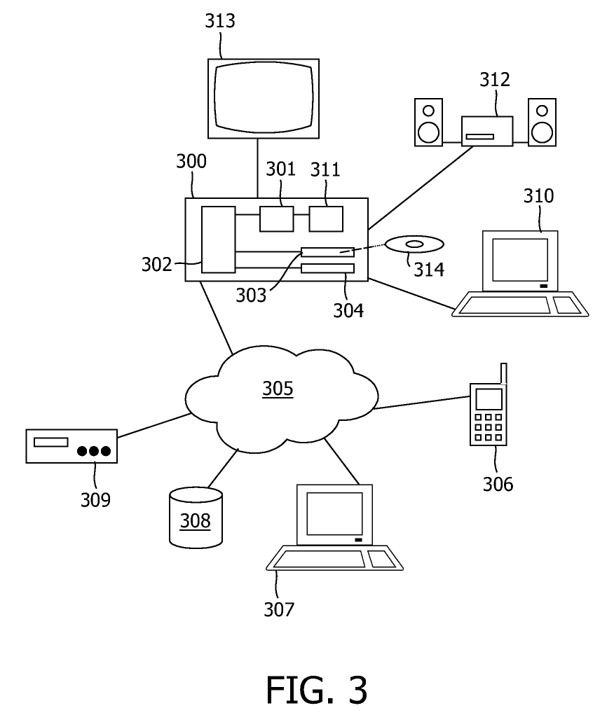

In FIG. 3, a device 300 such as a rendering device is equipped with a hardware platform 301 with processing capability, the hardware platform being connected to or including the reconfigurable hardware component 311. The rendering device may be a general purpose computer, a hard disk recorder etc., integrated with or connected to a screen 313 for showing image data such as video and/or an audio device 312 for playback of sound, e.g. music, to another computer 310, possible part of a network, etc. The rendering device is also equipped with an interface for connecting the device to a disc drive 303, e.g. a DVD drive, a HD drive, a Blu-ray drive, etc., a storage unit 304, e.g. a hard disk, and a network 305, such as an Intranet, the Internet, a home network. The network may further be connected to other units, including mobile units 306, computers 307, servers 308, media centers 309, hard disk recorders, etc.

The device 300 may, and typically will, include additional or alternative components and elements, which are not described in connection with the present embodiment.

In an embodiment, a user wishes to access protected content, e.g. a downloaded film or a film present on a DVD disc or other storage device 314. The film may be encrypted, and needs to be decrypted in order to view the film. The encrypted content is accompanied by decryption instructions, e.g. keys, instruction relating to the decryption algorithm, instructions where to find an embedded watermark, which need to be present in order to be able to playback. The first application may then configure the reconfigurable hardware component 311 so that the rendering device is able to perform these tasks. Also the reconfiguration set may accompany the content, e.g. as data on the disc 314, as data downloaded together with the content, etc.

In an embodiment, the content is in a data format which is not understandable to a standard processor, and where the rendering device is controlled directly by the reconfigured hardware component.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method of executing computer readable instructions on a hardware platform (20, 301) comprising a reconfigurable hardware component (21, 311), the method comprising:
reconfigure the reconfigurable hardware component in accordance with a reconfiguration set (26);
execute a first application (10) at least partly on the reconfigured hardware component and generate an output (25, 108) from the first application.

2. Method according to claim 1, wherein the reconfigurable hardware component is a field-programmable gate array.

3. Method according to claim 1, wherein the reconfigured hardware component has the function of a CPU (103).

4. Method according to claim 1, wherein the reconfigured hardware component is adapted for parallel processing (104).

5. Method according to claim 1, wherein the reconfigured hardware component forms a neural network (105).

6. Method according to claim 1, wherein an access level is set in dependence on the output of the first application (25, 108).

7. Method according to claim 6, wherein the first application performs an integrity test on itself, and wherein the level of access is set in dependence on the integrity test.

8. Method according to claim 6, wherein the first application performs an integrity test on the reconfigurable hardware component (21, 311), and wherein the level of access is set in dependence on the integrity test.

9. Method according to claim 6, wherein the first application performs an integrity test on a software application running on the hardware platform (20), and wherein the level of access is set in dependence of the integrity test.

10. Method according to claim 6, wherein the level of access is further dependent upon the execution of a software application running on the hardware platform.

11. Method according to claim 1, wherein the first application enables execution of instructions associated to encrypted content.

12. Method according to claim 1, wherein the reconfiguration set is accompanied by encrypted content, and wherein the reconfiguration set enables the first application to execute instructions associated to the encrypted content.

13. A computer program product arranged to cause a processor to execute the method of claim 1.

14. Device (300) comprising a hardware platform (20, 301) and a reconfigurable hardware component (21, 311), wherein the reconfigurable hardware component is reconfigured in accordance with a reconfiguration set (26); and a first application (10) is executed at least partly on the reconfigured hardware component, thereby generate an output (25, 108) from the first application.
